(19) United States
(12) Patent Application Publication
(10) Pub. No.: US 2023/0101549 A1
(43) Pub. Date: Mar. 30, 2023

(54) SYSTEM FOR HANDLING BLISTER PACKS

(71) Applicant: PHARMAWORKS LLC, Odessa, FL (US)

(72) Inventors: Ingo FEDERLE, Odessa, FL (US); Jose A. VELAZCO, Lutz, FL (US)

(21) Appl. No.: 17/951,729

(22) Filed: Sep. 23, 2022

Related U.S. Application Data
(60) Provisional application No. 63/248,534, filed on Sep. 26, 2021.

(51) Int. Cl. B65G 47/61; B65G 17/32; B65G 54/02

(52) U.S. Cl. CPC B65G 47/61; B65G 17/323; B65G 54/02

(57) ABSTRACT

A system for handling blister packs includes an overhead vacuum conveyor for conveying blister packs in a first direction. A plurality of conveying elements are mounted for movement along a running rail, wherein each conveying element includes a first blister pack carrier and each blister pack is shifted down from the overhead vacuum conveyor into a respective blister pack carrier.

### TECHNICAL FIELD

This application relates generally to handling of blisters that are used in blister packs and, more specifically, to a system for handling blisters as they are produced.

### BACKGROUND

A blister pack is a type of pre-formed plastic packaging used for small consumer goods, foods, and for pharmaceuticals. The primary component of a blister pack is a blister element that includes one or more cavities or pockets made from a formable web, usually a thermoformed plastic. To create the final blister pack, a backing of paperboard or a lidding seal of aluminum foil or plastic is applied to the blister after the filing of the cavity of cavities. Often times blister packs include multiple cavities or pockets, all of which are individually sealed by the backing or lidding.

The blister/cartoner industry and end users have struggled for years to have a simple, effective, and easy to utilize system to transfer blister packs from the blister production machines to the cartoner and/or other downstream equipment. Typical systems have numerous drawbacks, such as: the need for many change parts; a high skill level required for adjustments, and setup; unreliable counting technology; limited production speed capabilities; wear parts; complex to maintain; mechanical transfer has limited applications and achievable speeds; very rigid connection between upstream and downstream equipment—often vendor locking the client; and limited change part availability.

It would be desirable to provide an improved system for handling blister packs as they are produced.

### SUMMARY

In one aspect, a blister pack handling system includes an overhead vacuum conveyor and a linear transfer conveyor to make the blister pack transfer simple, effective and easy to use.

In another aspect, a system for handling blister packs includes an overhead vacuum conveyor for conveying blister packs in a first direction. A plurality of conveying elements are mounted for movement along a running rail, wherein each conveying element includes a first blister pack carrier and each blister pack is shifted down from the overhead vacuum conveyor into a respective blister pack carrier.

In still another aspect, a system for handling blister packs includes an overhead conveyor for conveying blister packs in a first direction toward a blister drop location. A conveying system is located below the overhead conveyor and includes a plurality of conveying elements mounted for movement along a running rail, wherein each conveying element includes a first blister pack carrier. The running rail includes an upper straight section, a lower straight section and a curved section between the upper straight section and the lower straight section. At least part of the upper straight section runs in a second direction below the blister drop location of the overhead conveyor, the second direction being transverse to the first direction. At least part of the lower straight section runs above a further conveyor that includes second blister pack carriers.

In a further aspect, a method of handling a blister pack, involves the steps of: conveying a blister pack, via an overhead conveyor, in a first direction toward a blister pack drop location; utilizing a conveying system in the form of a running rail with multiple conveying elements that are selectively and individually movable along the running rail independently of one another, the running rail including an upper straight section that runs in a second direction, transverse to the first direction, at least part of the upper straight section passing under the blister pack drop location; moving a first conveying element, of the multiple conveying elements, into a receiving position below the blister pack drop location and stopping the first conveying element at the receiving position; dropping the blister pack from the overhead conveyor into a first blister pack carrier that is coupled to the first conveying element; moving the first conveying element from upper straight section around a curved section of the running rail and to a lower straight section of the running rail, thereby inverting the first blister pack carrier; and dropping the blister pack out of the first blister pack carrier an onto a further conveyor that runs substantially parallel to a conveyance direction of the lower straight section of the running rail.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1-3 are perspective views of a blister handling system;

FIGS. 4-13 are side perspective views of the blister handling system in operation.

### DETAILED DESCRIPTION

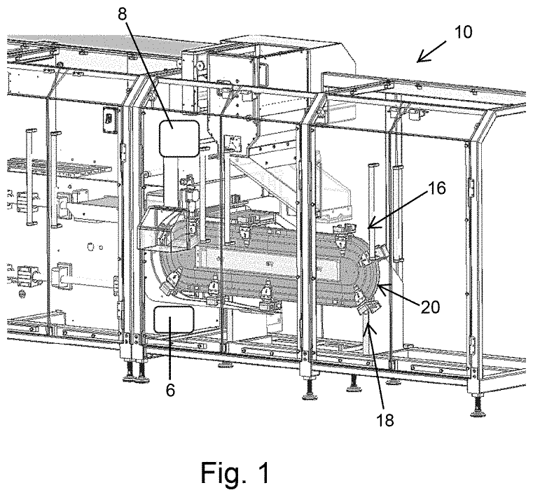

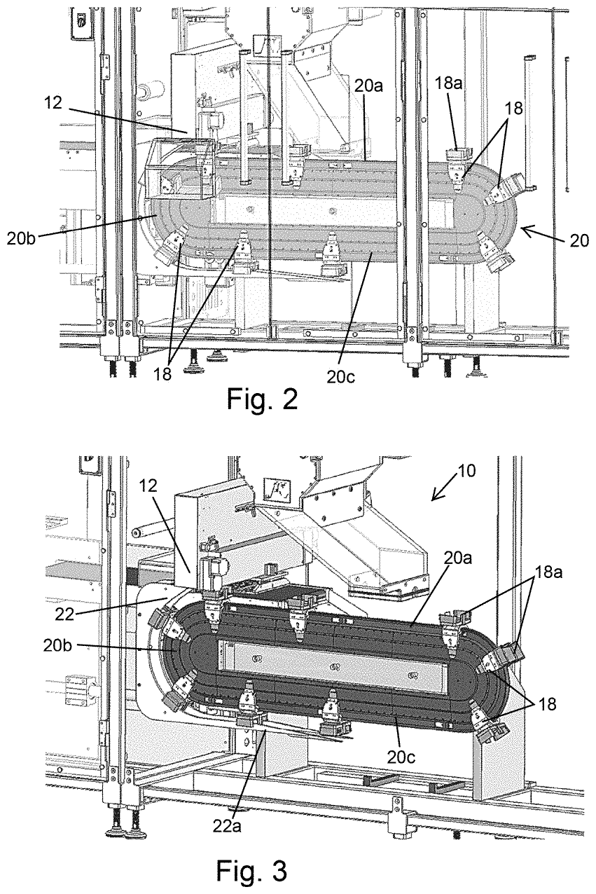

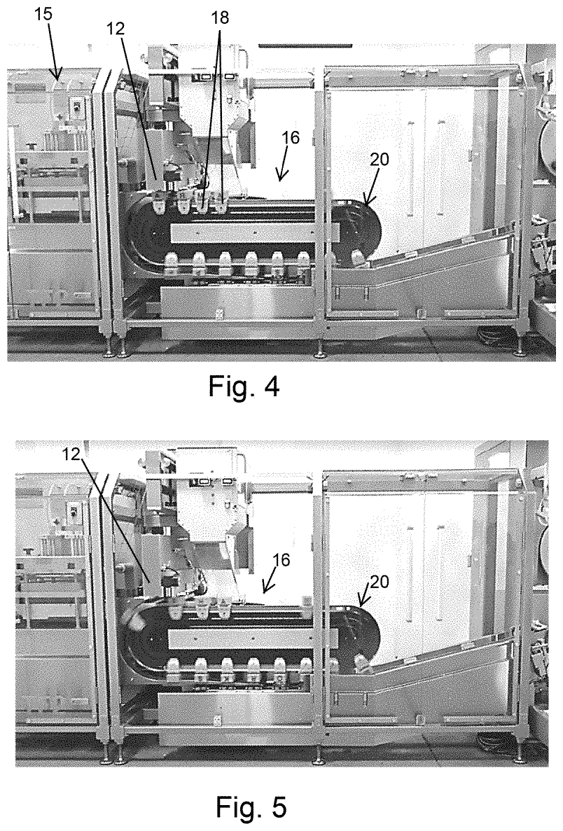

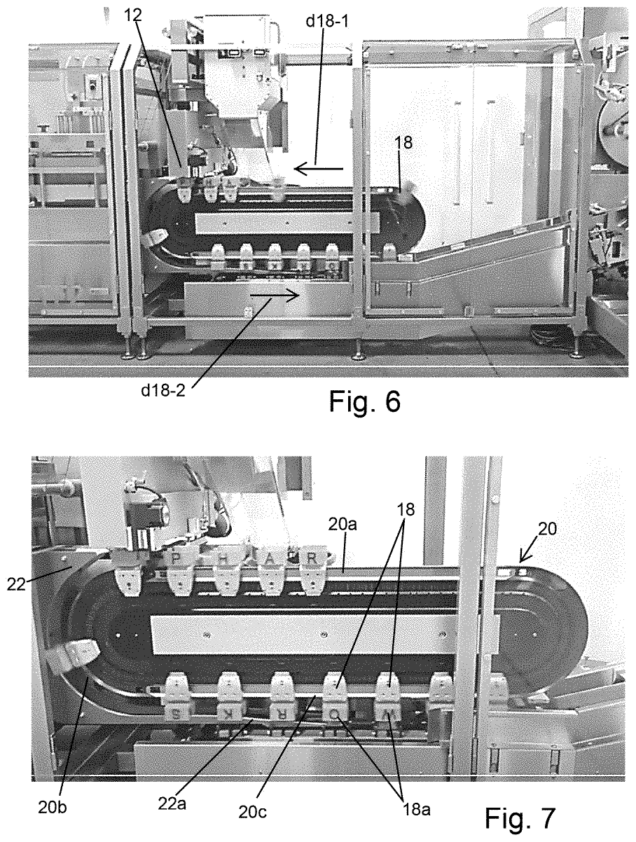

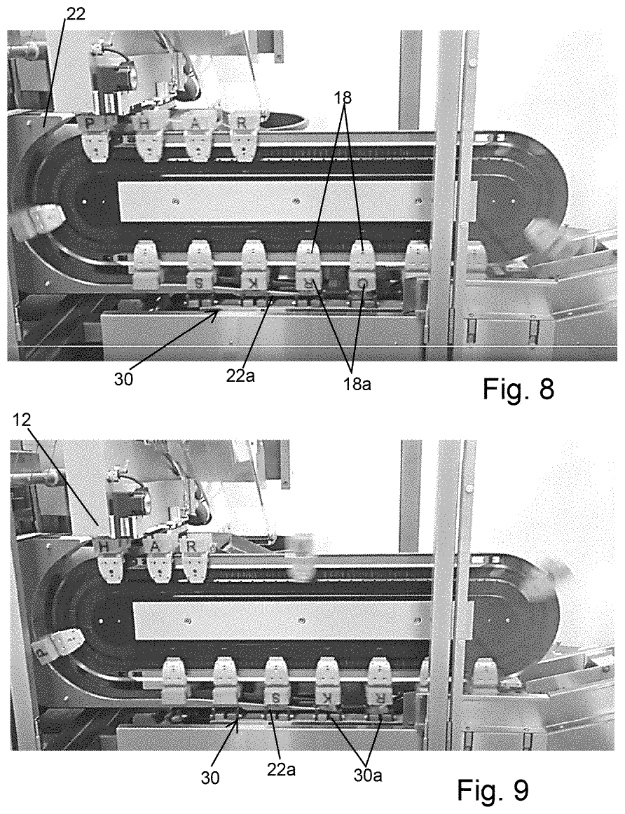

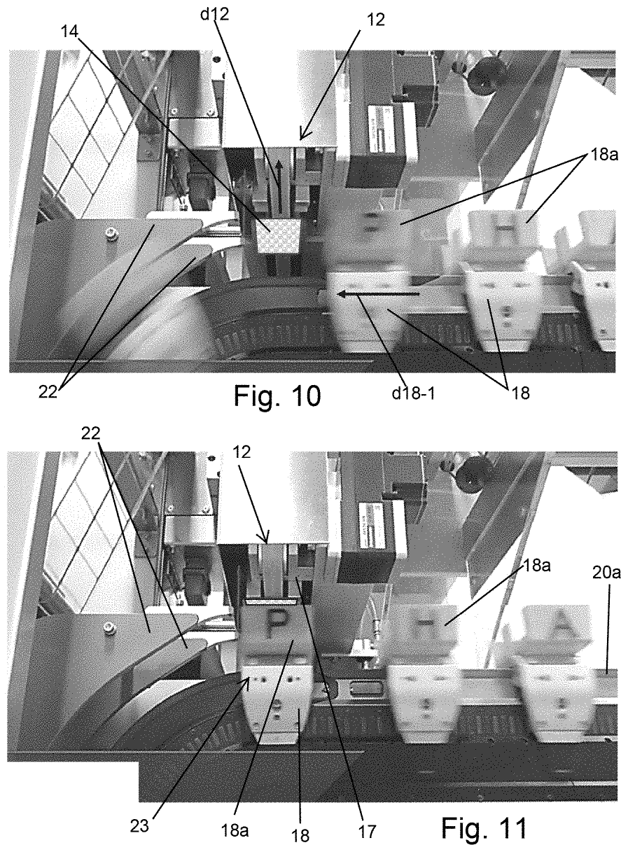

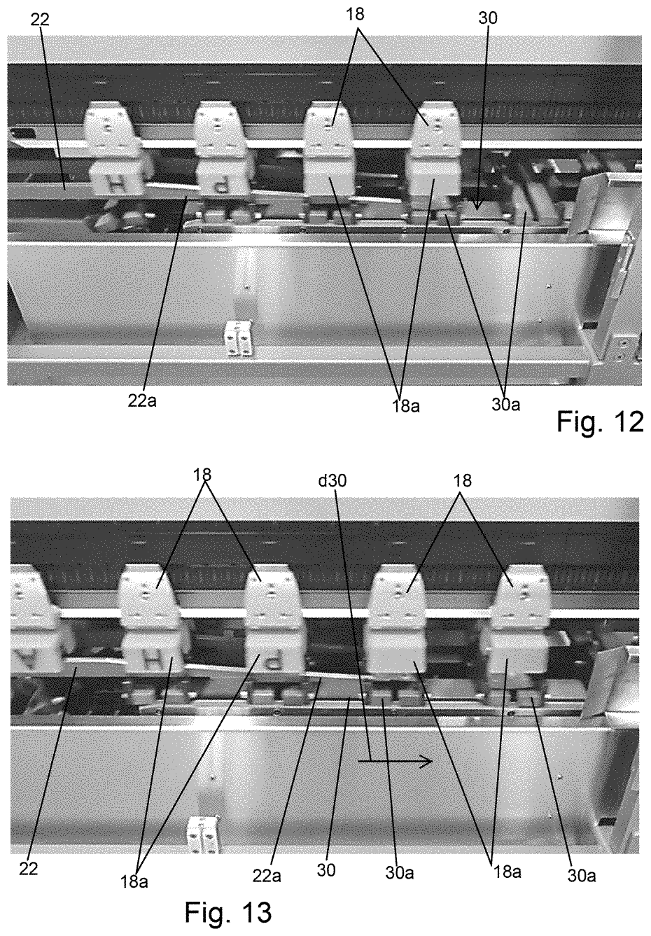

Referring to FIGS. 1-13, an exemplary blister pack handling system 10 is shown and includes an overhead vacuum conveyor 12 that delivers blister packs 14 to a linear transfer conveyor 16 that includes multiple conveying elements or movers 18 mounted for movement about a running rail or conveyor rail 20. The running rail 20 has a design with linear part regions as well as curved regions such that in total an oval-shaped loop section is produced. However, systems with other shapes could also be implemented. The segments of the running rail 20 incorporate linear motor modules or devices, which define a plurality of coils which are arranged in and sequentially along the running rail. Permanent magnets are typically arranged on the conveying elements 18. This means that the conveying elements 18 can be driven independently of each other. In this case, an electromagnetic moving field is generated by the motor coils, and the conveying elements 18 follow the moving fields by means of magnetic coupling and consequently are moved along the running rail 20. The system includes an associated power supply unit 6 for providing current for coil energization. A control system includes a controller 8 (e.g., any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the hood or the control functions of the system or any component thereof) connected with the rail, and associated circuitry on the rail, for selective control of the energization level of individual coils, as well as components for monitoring the individual position and velocity of each of the conveying elements 18. One example of such a transport system is the Beckhoff XTS linear transport system.

The system 10 enables each conveying element 18 to be programmed and commanded to travel to any location along the running rail 20, providing data to the controller about the precise location of the conveying element 18. Here, each conveying element 18 includes a specifically designed and engineered tooling 18a that is configured to receive a specific blister pack shape and size. Here, the tooling 18a is in the form of “buckets” into which the blister packs 14 are dropped by the overhead conveyor 12. Other configurations of blister pack carriers could also be used.

Here, the overhead vacuum conveyor 12 transports the blister packs 14 in a direction d12 that is substantially perpendicular to the conveyance direction d18-1 of the conveyance elements 18 as the elements are moved along an upper straight section 20a of the running rail 20 into a set drop position 23 beneath an end section of the overhead vacuum conveyor 12. The overhead conveyor 12 receives the blister packs from blister production machinery 15, such as a thermoformer. By way of example, a pneumatic kicker 17 may be used to remove the blister packs from the overhead vacuum conveyor so as to drop them into the tooling/bucket 18a. Each blister pack 14 is aligned with a stop gauge before the kicker pushes the blister pack down into the waiting tooling/bucket 18a.

Once a blister pack 14 is transferred into a tooling/bucket 18a, the conveyance element 18 is accelerated away from the drop position and begins a transition downward around the curved section 20b of the running rail 20. One or more guides 22 (two shown here) are positioned along the curved section 20b and are positioned to interact with the tooling/bucket 18a to cause the blister back to remain in the tooling/bucket 18a even as the tooling/bucket 18a is shifted to an inverted orientation after traversing the curved section 20b and moving onto a lower straight section 20c of the running rail. The guides 22 follow part of the lower straight section 20c and have end sections 22a that taper downward, further away from the running rail, so that the blister pack 14 will begin to fall down out of the tooling/bucket 18a upon continued travel of the element 18 (in travel direction d18-2) along the lower straight section 20c of the running rail.

A further conveyor 30 runs below the running rail and includes tooling/buckets 30a, or some other form of blister pack carrier, (traveling in direction d30, which is substantially parallel to direction d18-2) into which the blister packs 14 drop once the tooling/buckets 18a move past the distal ends 22b of the guides 22. The further conveyor 30 may, for example, be a cartoner conveyor that moves the blister packs onto a station at which the blister packs can be shifted laterally into cartons. For the purpose of the transfer from the first blister pack tooling element 18a to the second blister pack tooling element 30a, the control system is configured to control the speed of the conveying element 18 to match the speed of the moving tooling element 30a along the further conveyor 30 and to align the tooling element 18a above the tooling element 30a. Notably, the further conveyor 30 typically moves at a different speed than the output from the thermoformer. However, the linear transfer conveyor 16 enables the speeds to be matched without the need for a magazine.

The described system provides numerous potential advantages, such as: connecting asynchronous equipment making the process synchronous, handling extremely shallow blisters; reduced change parts that can be printed with a 3-D printer; simple maintenance—easy to maintain and replace parts; no magazine; less change parts; connect two (2) independent machines with ease; compact design; integrated overflow on the input side (on overhead transfer)—allowing the process to be continuous without interrupting operation of the upstream or downstream equipment; default count accuracy is increased and handling is done with minimum intervention.

The system works on demand. Unlike a magazine on a pendulum which moves with a cartoner even if no blister packs are coming, the transfer bucket style tooling sits idle when no blister packs need to get transferred.

It is to be clearly understood that the above description is intended by way of illustration and example only, is not intended to be taken by way of limitation, and that other changes and modifications are possible.

1. A system for handling blister packs, comprising:
an overhead vacuum conveyor for conveying blister packs in a first direction;
a plurality of conveying elements mounted for movement along a running rail, wherein each conveying element includes a first blister pack carrier and each blister pack is shifted down from the overhead vacuum conveyor into a respective blister pack carrier.

2. The system of claim 1, further comprising a control system configured such that each conveying element is controlled to be moved into a set drop position below an end section of the overhead vacuum conveyor for receiving a blister pack.

3. The system of claim 2, wherein each conveying element is moved along an upper straight section of the running rail in a second direction as the conveying element is moved into the set drop position, wherein the second direction is substantially perpendicular to the first direction.

4. The system of claim 3, wherein each conveying element is accelerated away from the set drop position after receiving a blister pack and moved along a curved section of the running rail to shift the blister pack carrier toward an inverted orientation.

5. The system of claim 4, further comprising at least one guide positioned along the curved section of the running rail and configured to interact with the blister pack carriers to cause the blister packs to remain in the blister pack carriers even as the blister pack carriers are shifted to the inverted orientation after traversing the curved section and moving onto a lower straight section of the running rail.

6. The system of claim 5, wherein the guide continues along part of the lower straight section of the running rail and includes an end section that tapers downward, further away from the running rail, so that the blister packs will begin to fall down out of the blister pack carriers upon continued travel along the lower straight section of the running rail.

7. The system of claim 6, further comprising:
a further conveyor that runs below the running rail and includes second blister pack carriers into which the blister packs drop once the first blister pack carriers move past a distal end of the guide.

8. A system for handling blister packs, comprising:
an overhead conveyor for conveying blister packs in a first direction toward a blister drop location;
a conveying system below the overhead conveyor and comprising a plurality of conveying elements mounted for movement along a running rail, wherein each conveying element includes a first blister pack carrier, wherein the running rail includes an upper straight section, a lower straight section and a curved section between the upper straight section and the lower straight section, wherein at least part of the upper straight section runs in a second direction below the blister drop location of the overhead conveyor, the second direction being transverse to the first direction, wherein at least part of the lower straight section runs above a further conveyor that includes second blister pack carriers.

9. The system of claim 8 wherein the lower straight section runs substantially parallel to a conveying direction of the further conveyor.

10. The system of claim 8, wherein the overhead conveyor includes a kicker for shifting blister packs off of the overhead conveyor and down into the first blister pack carriers.

11. A method of handling a blister pack, comprising:
conveying a blister pack, via an overhead conveyor, in a first direction toward a blister pack drop location;
utilizing a conveying system in the form of a running rail with multiple conveying elements that are selectively and individually movable along the running rail independently of one another, the running rail including an upper straight section that runs in a second direction, transverse to the first direction, at least part of the upper straight section passing under the blister pack drop location;
moving a first conveying element, of the multiple conveying elements, into a receiving position below the blister pack drop location and stopping the first conveying element at the receiving position;
dropping the blister pack from the overhead conveyor into a first blister pack carrier that is coupled to the first conveying element;
moving the first conveying element from upper straight section around a curved section of the running rail and to a lower straight section of the running rail, thereby inverting the first blister pack carrier; and
dropping the blister pack out of the first blister pack carrier an onto a further conveyor that runs substantially parallel to a conveyance direction of the lower straight section of the running rail.

12. The method of claim 11, wherein the blister pack is dropped onto a second blister pack carrier that is conveyed by the further conveyor, and a speed of the first blister pack carrier is matched to a speed of the second blister pack carrier for purpose of dropping the blister pack onto the second blister pack carrier of the further conveyor.
